(19) United States
(12) Patent Application Publication
(10) Pub. No.: US 2019/0024833 A1
(43) Pub. Date: Jan. 24, 2019

(54) Female Connector of a Plug-In Connector and Plug-In Connector

(71) Applicant: MATZ ERREKA, S.COOP., ANTZUOLA (ES)

(72) Inventors: Juan Cruz LIZARRALDE ITURBE, ANTZUOLA (ES); Naroa ITURRIOZ SOTO, BERMEO (ES)

(21) Appl. No.: 16/037,383

(22) Filed: Jul. 17, 2018

(30) Foreign Application Priority Data
Jul. 20, 2017 (EP) 17382481.4

(51) Int. Cl. F16L 37/14; F16L 37/088; F01P 11/04

(52) U.S. Cl. CPC F16L 37/144; F01P 11/04; F16L 37/088

(57) ABSTRACT

According to one embodiment a plug-in connector is provided that includes a female connector and a male connector. The female connector includes a head configured for being connected to the male connector and a body fixed to the head which is configured for being attached to a pipe/hose. A contact area comprising a line of contact communicated with the inside of the female connector is defined between the head and the body. The plug-in connector also includes a sealing gasket configured for assuring leak-tightness between the female connector and the male connector, the line of contact being arranged in a previous axial position with respect to at least part of the sealing gasket in the direction of insertion of the male connector into the female connector, such that the sealing gasket itself also assures the leak-tightness in the line of contact.

### CROSS-REFERENCE TO RELATED APPLICATIONS

This application relates to and claims the benefit and priority to European Application No. EP17382481.4, filed Jul. 20, 2017.

### TECHNICAL FIELD

The present invention relates to connectors for rigid and flexible tubes wherein a male connector is coupled to a female connector, and more specifically to connectors where one of the connectors comprises two parts attached to one another.

### BACKGROUND

Plug-in connectors comprising a female connector and a male connector are known, wherein each connector is fixed at one end to a rigid or flexible tube, the connectors interacting with one another for fluidically joining both tubes in a fast and efficient manner.

In connectors of this type, the free end of the female connector usually comprises retention means, generally a U-shaped rod, cooperating with the male connector for retaining it inside the female connector. During insertion of the male connector, the retention means are elastically deformed and they return to their original position when the retention means contact a recess or groove arranged in the male connector, such that the male connector is retained by the elastic means.

Connectors wherein the female connector is made up of two parts attached to one another to form a single part are also known.

In this sense, US20100176589A1 discloses a female connector comprising a head attached to a body. The female connector is configured for being connected to a male connector. A contact area comprising a line of contact, which is communicated with the inside of the female connector, is defined between the head and the body of the female connector. The female connector also comprises a sealing gasket for assuring leak-tightness between the female connector and the male connector.

### SUMMARY OF THE DISCLOSURE

A plug-in connector is provided that includes a female connector and a male connector that can be coupled to the female connector. The female connector comprises a head configured for being connected to a male connector and a body fixed to the head which is configured for being attached to a pipe/hose. A contact area comprising a line of contact communicated with the inside of the female connector is defined between the head and the body. The plug-in connector also comprises a sealing gasket configured for assuring leak-tightness between the female connector and the male connector.

In the female connector of the invention, the line of contact is arranged in a previous axial position with respect to at least part of the sealing gasket in the direction of insertion of the male connector into the female connector, such that the sealing gasket itself also assures the leak-tightness in the line of contact.

Different types of connectors, for example linear connectors, elbow connectors, etc., which allow being adapted to different usage needs according to their environment, can be formed in a quick and efficient manner, and with the minimum number of parts possible, using the female connector. Likewise, the leak-tightness between the male connector and the female connector, and between both parts of the female connector, can be assured using a single sealing gasket.

These and other advantages and features will become evident in view of the drawings and the detailed description.

### BRIEF DESCRIPTION OF THE DRAWINGS

FIG. 1A shows an exploded, sectioned view of a plug-in connector according to one embodiment, wherein the female connector and the male connector are not coupled.

FIG. 1B shows an exploded, sectioned view of the female connector of the plug-in connector of FIG. 1A but without the sealing gasket.

FIG. 2A shows a cross-section of the female connector of FIG. 1A.

FIG. 2B shows a first detail of the female connector of FIG. 1A.

FIG. 2C shows a second detail of the female connector of FIG. 1A but without the sealing gasket.

FIG. 2D shows a detail of the female connector of FIG. 1A, once the body and the head are fixed to one another.

FIG. 2E schematically shows the male connector introduced in the already fixed female connector of FIG. 1A.

FIG. 3 shows a detail of the head of the female connector of FIG. 1A.

FIG. 4 shows a detail of the body of the female connector of FIG. 1A.

FIG. 5 shows a perspective view of the body of the female connector of FIG. 1A.

FIG. 6 shows a perspective view of the head of the female connector of FIG. 1A.

### DETAILED DESCRIPTION

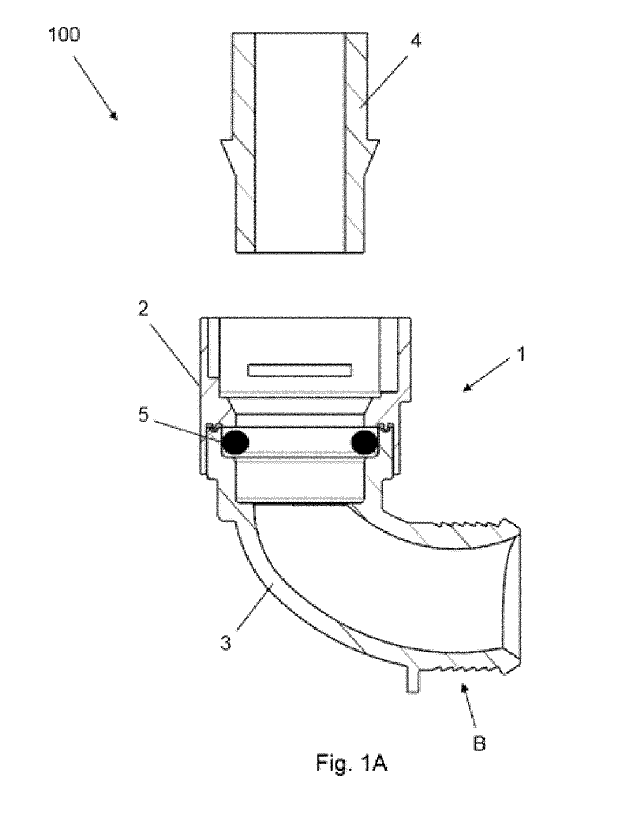

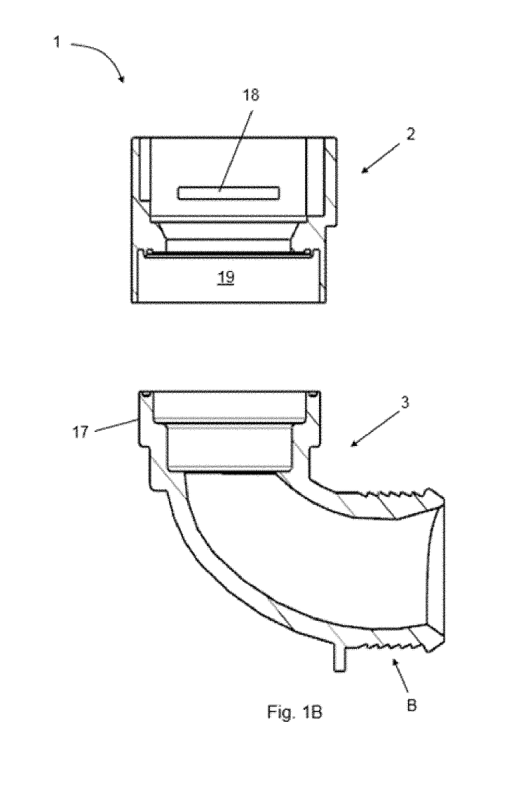

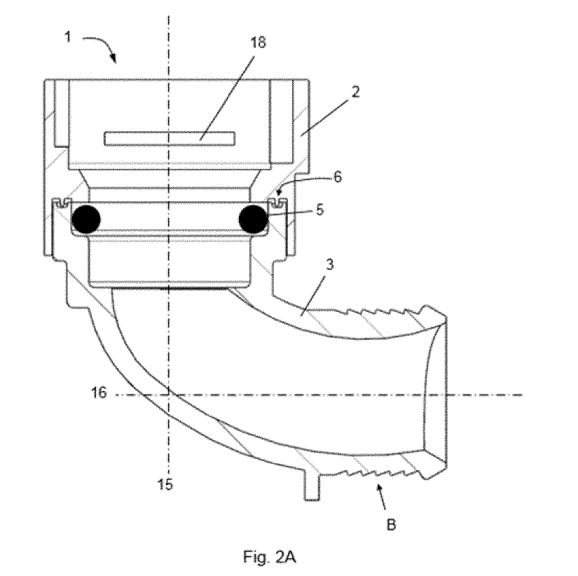

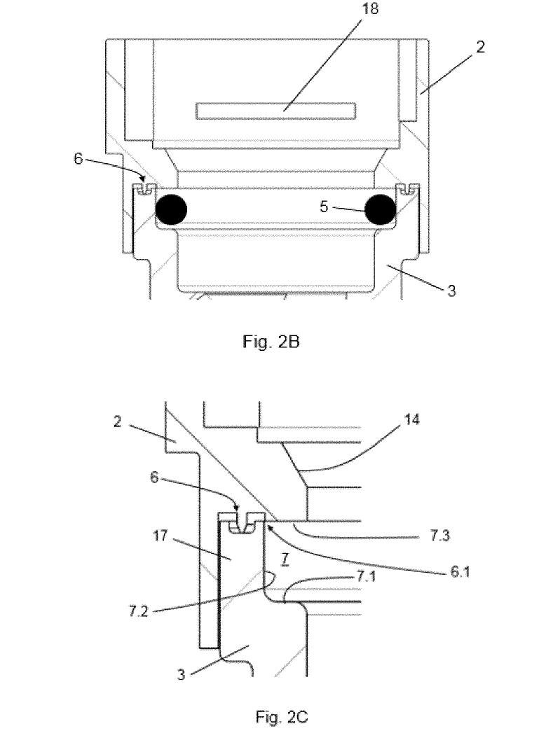

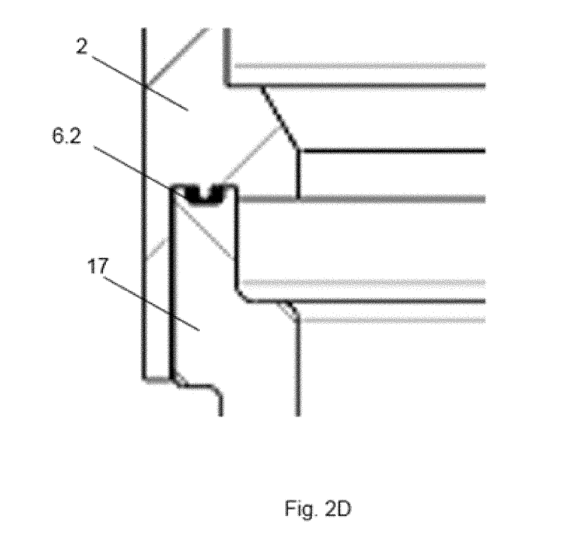

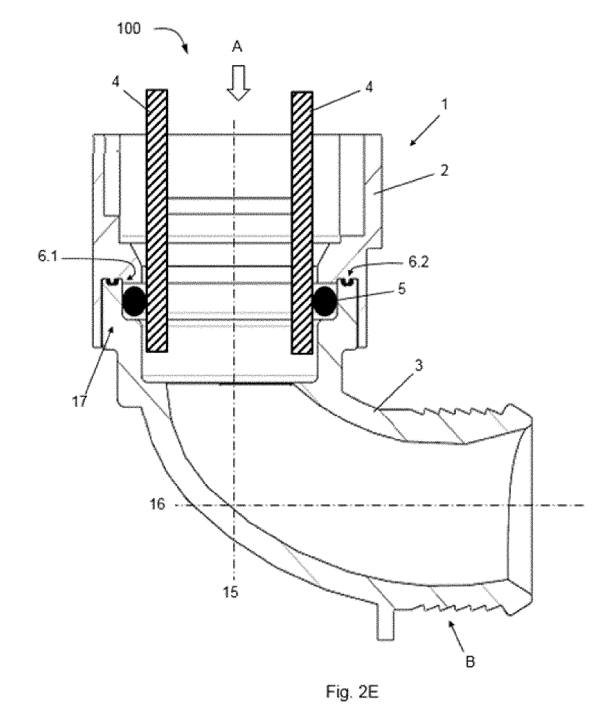

FIG. 1A shows the plug-in connector 100 according to a preferred embodiment of the invention. As shown in the figure, the connector 100 comprises a female connector 1 and a male connector 4 that can be coupled to the female connector 1. Both the female connector 1 and the male connector 4 are configured for being attached at one end to a pipe or a hose (not shown in the drawings), such that the plug-in connector 100 makes it possible to establish a quick and effortless fluid communication between both pipes/hoses. Preferably, the end comprises a notched area B to favor attachment to the pipe/hose, as seen in FIGS. 1A, 1B, 2A, 2E, or 5 for the female connector 1.

The male connector 4 is introduced into the female connector 1 at the opposite end, as schematically depicted in FIG. 2E, the male connector 4 being retained inside the female connector 1 by elastic retention means (not shown in the drawings). The retention means is preferably in the form of a U-shaped wire.

As seen in FIGS. 1B and 2A, the female connector 1 comprises a head 2 configured for being connected to the male connector 4 and a body 3 which is permanently fixed to the head 2. The body 3 is configured for being attached to the pipe/hose (not shown in the drawings). A contact area 6 comprising a line of contact 6.1 communicated with the inside of the female connector 1 is defined between the head 2 and the body 3.

In the preferred embodiment, the head 2 comprises a recess 19 at one end for housing part of the body 3.

The retention means is arranged on the outer portion of the head 2 of the female connector 1, the arms of the retention means going through a respective groove 18 arranged in the head 2 to retain the male connector 4 when it is introduced in the female connector 1.

The plug-in connector 100 also comprises a sealing gasket 5, preferably an O-ring, configured for assuring leak-tightness between the female connector 1 and the male connector 4, shown in FIG. 2A, for example.

In the female connector 1, the line of contact 6.1 is arranged in a previous axial position with respect to at least part of the sealing gasket 5 in the direction of insertion A of the male connector 4 into the female connector 1, such that the sealing gasket 5 itself also assures the leak-tightness in the line of contact 6.1.

Since the female connector 1 is formed by at least two parts, the head 2 and the body 3, different types of connectors can be obtained in a simple, fast and efficient manner, and with the minimum number of parts. For example, linear connectors and different variants of elbow connectors can be obtained.

For the same diameter, a plethora of female elbow connectors 1 with two parts, i.e., with a body 3 attached to the head 2, can be obtained since the body 3 can be attached according to different positions. If it is desired to vary the angle of the elbow of the female connector 1, it is enough to obtain another body 3 with the angle, and different variants can be obtained by attaching the body 3 to the head 2 in different positions.

Obtaining the female connector 1 at least in two portions, i.e., the head 2 and the body 3, allows significantly reducing not only the number of parts but also the number of molds for manufacturing the final female connector 1.

However, as the skilled person knows, if a fluid is to be circulated through the inside of the parts, the leak-tightness in the attachment areas between different parts must be assured so that the fluid does not leak out.

In the case of the plug-in connector 100 disclosed herein, it will be necessary to assure that the fluid circulating through the inside of the connector 100 does not leak out through the male-female connector attachment on one hand, and does not leak out through the head-body attachment of the female connector 1 on the other.

Since the line of contact 6.1 between the head 2 and the body 3 is arranged in a previous axial position with respect to at least part of the sealing gasket 5 in the direction of insertion A of the male connector 4 into the female connector 1, the same sealing gasket 5 assuring the leak-tight closure between the female connector 1 and the male connector 4 also assures the leak-tight closure between the head 2 and the body 3 of the female connector 1, as will be described in detail below.

As the skilled person knows, sealing gaskets comprise a portion projecting radially from the housing of the gasket, as seen in FIG. 2A or 2B.

When the male connector 4 is introduced in the female connector 1 as depicted schematically in FIG. 2E, the outer wall of the male connector 4 presses on the sealing gasket 5, usually in the direction perpendicular to the axial direction of the female connector 1, causing the deformation of the sealing gasket 5. Therefore, as the skilled person knows, a sealing gasket will always assure a leak-tight closure in the direction where the closing pressure is exerted, in the example disclosed herein the direction perpendicular to the axial direction of the female connector 1, i.e., in the radial direction.

Therefore, the fluid circulating through the inside of the plug-in connector 100, i.e. through the inside of the male connector 4 and the female connector 1, cannot go through the sealing gasket 5 and the outer wall of the male connector 4, nor through the sealing gasket 5 and the side surface 7.2 of the housing 7, and therefore will not be able to access the line of contact 6.1 of the contact area 6 defined between the head 2 and the body 3 of the female connector 1, since the line of contact 6.1 is arranged in a previous axial position with respect to at least part of the sealing gasket 5 in the direction of insertion A of the male connector 4 into the female connector 1. The leak-tightness between the male connector 4 and the female connector 1, and between both parts 2 and 3 forming the female connector 1, can therefore be assured using a single sealing gasket 5.

In the embodiment of the invention shown in the drawings, the line of contact 6.1 between the head 2 and the body 3 of the female connector 1 is arranged in an previous axial position with respect to the sealing gasket 5 in the direction of insertion A of the male connector 4 into the female connector 1, as seen in FIGS. 2A or 2C.

To make insertion of the male connector 4 into the female connector 1 easier, the female connector 1 comprises therein a conical area 14 such that it gets narrower in the direction of insertion A of the male connector 4 into the female connector 1.

In the preferred embodiment of the invention, the conical area 14 is arranged in the head 2, preferably in a previous axial position with respect to the line of contact 6.1 between the head 2 and the body 3 in the direction of insertion A of the male connector 4 into the female connector 1, as seen in FIG. 2B.

The sealing gasket 5 of the invention is housed in a perimetral housing 7 which in the preferred embodiment of the invention is delimited by the body 3 and the head 2, as seen in FIG. 2C.

According to the example of FIG. 2C, the housing 7 is delimited by a perimetral support base 7.1 and 7.2 arranged in the body 3 and by a surface 7.3 of the head 2. The perimetral support base comprises a support surface 7.1 perpendicular to the axis of the female connector 1 and a side surface 7.2 parallel to the axis of the female connector 1, the surface 7.3 of the head 2 being arranged parallel to the support surface 7.1.

As described, the perimetral housing 7 is delimited by the body 3 and the head 2 according to the preferred embodiment of the invention, but optionally it may also be arranged in the body 3 or even in the head 2.

In the preferred embodiment of the invention, the contact area 6 between the head 2 and the body 3 comprises a perimetral attachment area 6.2, the head 2 and the body 3 being permanently attached in the attachment area 6.2, as will be described in detail below.

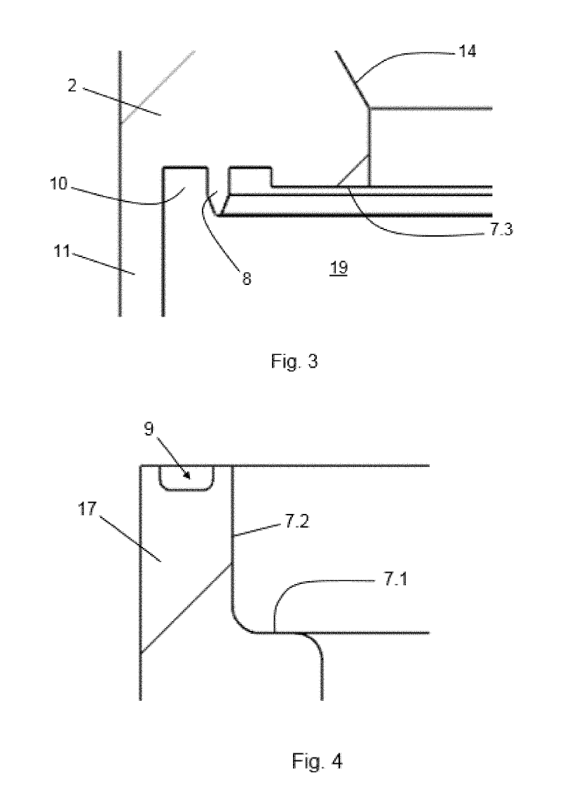

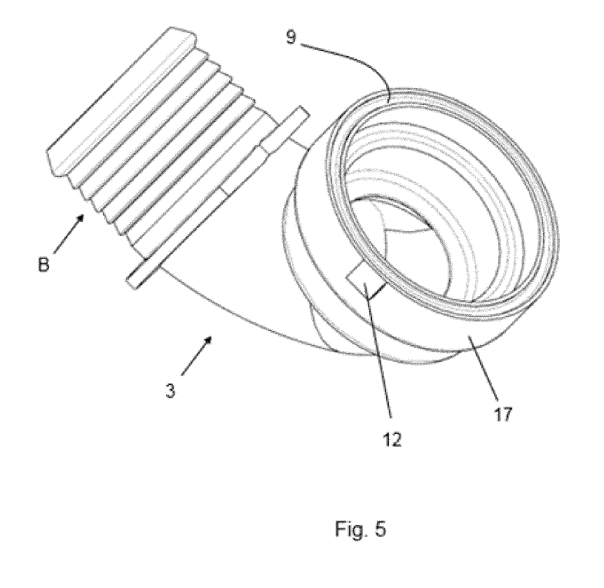

The attachment area 6.2 is a portion of the contact area 6 where the head 2 and the body 3 are permanently attached, preferably by ultrasonic welding. FIG. 2D shows a detail of the attachment area 6.2 between the head 2 and the body 3 after carrying out the welding process. The attachment area 6.2 is carried out in a perimetral recess 9, shown in FIG. 4, which according to the preferred embodiment is arranged in the body 3, preferably at the end 17 cooperating with the head 2, although optionally it could also be arranged in the head 2. According to the preferred embodiment of the invention, the head 2 comprises a protuberance 8, shown in FIG. 3, the protuberance 8 being housed in the recess 9 such that the protuberance 8 does not project from the recess 9 during the welding process for forming the attachment area 6.2.

According to the embodiment shown in the drawings, the protuberance 8 projects from a perimetral recess 10, as shown in the detail of FIG. 3.

Focused heating occurs during the welding process, in this case in the attachment area 6.2, causing the localized melting of the contacting parts to be welded, in this case the protuberance 8 and part of the recess 9.

In the example shown in the figures, part of the protuberance 8 is melted, the recess 9 collecting the molten material such that it does not spill over, the molten material solidifying inside the recess 9. The molten material is thereby prevented from rising to the surface of the female connector 1, or from being able to reach the inside of the female connector 1.

Even in the hypothetical case in which the molten material spills over the recess 9 of the body 3, the molten material would be advantageously retained in the recess 10 of the head 2, the recess 10 providing sides walls which prevent the molten material from being able to pass into the female connector 1 or to rise towards the outside of the female connector 1.

The perimetral recess 9 may be arranged in the head 2 instead of in the body 3, then the protuberance 8 may be arranged in the body 3 and not in the head 2.

If the fluid circulating through the inside of the plug-in connector 100 reaches the contact area 6.2, seeping out through the line of contact 6.1 and the contact area 6, the fluid can damage the attachment between the head 2 and the body 3 over time, even being able to cause the separation of both parts 2 and 3.

To prevent this phenomenon, the line of contact 6.1 is advantageously arranged in a previous axial position with respect to the sealing gasket 5 in the direction of insertion A of the male connector 4 into the female connector 1, as described; therefore, the fluid circulating through the inside of the plug-in connector cannot access the line of contact 6.1, and therefore the attachment area 6.2. With respect to the direction of insertion A of the male connector 4, at least a portion of the sealing gasket 5 is located downstream the attachment area 6.2.

According to the preferred embodiment, the head 2 comprises a perimetral side wall 11 partially covering the body 3, as shown in FIGS. 2A, 2B or 2D, the wall 11 being the wall of the recess 19 of the head 2 where the body 3 is housed.

The contact area between the side wall 11 and the body 3 is part of the contact area 6, but in the preferred embodiment, there is no attachment area in said portion, although the possibility of there being another contact area along contact area 6 is not ruled out. That is, according to one embodiment there is an attachment of the side wall 11 to the body 3.

As described, a plurality of connectors 1, such as elbow connectors, can be obtained with the minimum number of tools and intermediate parts by dividing the female connector 1 into two parts, i.e., in the head 2 and the body 3. For example, by positioning a bent body 3 with respect to the head 2 according to different angles, different configurations of the female connector 1 can be obtained without having to invest too much in tools.

According to one embodiment the female connector 1 is an elbow connector formed by the head 2 comprising a linear axial axis 15, and a bent body 3 comprising an end 17 cooperating with the head 2 (the end 17 being housed in the recess 19 of the head 2) and comprising a linear axial axis 15 which coincides with the axial axis 15 of the head 2 once the body 3 is fixed to the head 2, and another end, preferably the end comprising the notched area to favor attachment to the pipe/hose, comprising an axial axis 16, in this case perpendicular to the axial axis 15 of the end 17, both ends being joined by a hollow curved area. In the example shown, the female connector 1 is a 90° elbow connector, any angle being able to be obtained at the second end.

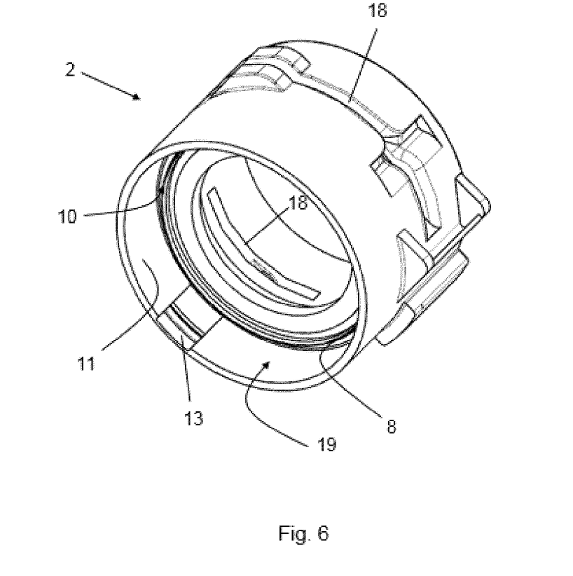

To accurately know the relative position between the head 2 and the body 3 before permanently fixing both parts to form the female connector 1 with the desired configuration, the body 3 comprises a radial side protuberance 12, shown in FIG. 5, and the side wall 11 of the head 2 comprises on the inner surface thereof a guiding groove 13, shown in FIG. 6, also radial, such that the protuberance 12 of the body 3 is housed in the guiding groove 13 of the side wall 11 of the head 2, the relative position between both parts 2 and 3 being defined.

Since the protuberance 12 of the body 3 and the guiding groove 13 of the head 2 are radial in nature, undercuts are not generated in the corresponding molds and the position thereof in the mold can be readily changed.

What is claimed is:

1. A female connector of a plug-in connector comprising:
a head configured for being connected to a male connector, the head having a central axis, the head having an internal through passage, a first end configured to receive a male connector and a second end;
a body having an internal through passage in fluid communication with the internal through passage of the head, the body including a first end attached to the head and a second end configured for being attached to a pipe or hose, the first end of the body being attached to the head along an attachment area disposed within a contact line defined between the head and the body; and
a sealing gasket located radially inward of the attachment area with at least a portion of the sealing gasket being located axially downstream of the attachment area, the sealing gasket being deformable to abut with a portion of the body and/or a portion of the head to form a leak-tight seal between the male and female connectors when the male connector is inserted through the head to press against the sealing gasket, the leak-tight seal preventing fluid contact with the attachment area when a fluid is passed through the female connector.

2. The female connector according to claim 1, wherein the sealing gasket is located in a housing delimited by the body and the head.

3. The female connector according to claim 2, wherein the housing of the sealing gasket is delimited by a support base arranged in the body, the support base comprising a support surface that is perpendicular to the central axis of the female connector, the housing further delimited by a side surface of the body that is parallel to the central axis of the female connector, and by a surface of the head that is arranged parallel to the support surface of the body.

4. The female connector according to claim 1, wherein the head and body are permanently attached along the attachment area.

5. The female connector according to claim 4, wherein the head and the body are attached along the attachment area by a weld.

6. The female connector according to claim 5, wherein the weld is an ultrasonic weld.

7. The female connector according to claim 1, wherein the attachment area comprises a protuberance of the head residing in a recess of the body, each of the protuberance and recess circumscribing the central axis of the head.

8. The female connector according to claim 7, wherein the head and body are permanently attached along the attachment area.

9. The female connector according to claim 5, wherein the attachment area comprises a protuberance of the head residing in a recess of the body, each of the protuberance and recess circumscribing the central axis of the head.

10. The female connector according to claim 1, wherein the attachment area comprises a protuberance of the body residing in a recess of the head, each of the protuberance and recess circumscribing the central axis of the head.

11. The female connector according to claim 10, wherein the head and body are permanently attached along the attachment area.

12. The female connector according to claim 5, wherein the attachment area comprises a protuberance of the body residing in a recess of the head, each of the protuberance and recess circumscribing the central axis of the head.

13. The female connector according to claim 7, wherein the protuberance projects from a recess in the head.

14. The female connector according to claim 10, wherein the protuberance projects from a recess of the body.

15. The female connector according to claim 1, wherein the second end of the head includes a recess with a portion of the body residing inside the recess.

16. The female connector according to claim 1, wherein the head comprises a side wall that covers an external surface of the body.

17. The female connector according to claim 10, wherein the body includes a side projection and the side wall of the head includes on an inner surface thereof a guiding groove, the projection being housed in the guiding groove to assure proper alignment of the body with the head.

18. A plug-in connector assembly comprising:
a male connector having an outer surface;
a female connector including:
a head configured for being connected to the male connector, the head having a central axis, the head having an internal through passage and a first end configured to receive a portion of the male connector and a second end;
a body having an internal through passage in fluid communication with the internal through passage of the head, the body including a first end attached to the head and a second end configured for being attached to a pipe or hose, the first end of the body being attached to the head along an attachment area between the head and the body; and
a sealing gasket located radially inward of the attachment area with at least a portion of the sealing gasket being located axially downstream of the attachment area, the sealing gasket being pressed against by the outer surface of the male connector so that the sealing gasket firmly abuts with a portion of the head and/or a portion of the body to form a leak-tight seal between the male and female connectors, the leak-tight seal preventing fluid contact with the attachment area when a fluid is passed through the male and female connectors.

19. The plug-n connector assembly according to claim 18, wherein the second end of the head includes a recess with a portion of the body residing inside the recess.

20. The plug-in connector assembly according to claim 18, wherein the head and body of the female connector are permanently attached along the attachment area.
